(19) United States
(12) Patent Application Publication
(10) Pub. No.: US 2014/0036959 A1
(43) Pub. Date: Feb. 6, 2014

(54) TEMPERATURE SENSOR

(71) Applicant: Shi-Wen CHEN, Kaohsiung City (TW)

(72) Inventor: Shi-Wen CHEN, Kaohsiung City (TW)

(21) Appl. No.: 13/565,798

(22) Filed: Aug. 3, 2012

(51) Int. Cl. G01K 7/01; G01K 7/00

(52) U.S. Cl. 374/170; 374/E07.001; 374/E07.036

(57) ABSTRACT

A temperature sensor includes two signal delaying apparatuses having the same internal circuit structure, a comparison apparatus, a multiplier, and a counting apparatus. One signal delaying apparatus is for delaying the phase of a step signal according to a temperature degree so as to form a first output signal. The other signal delaying apparatus operates at ZTC point and is for delaying the phase of the step signal so as to form a second output signal. The comparison apparatus receives the first and second output signals so as to output a third output signal accordingly. The multiplier receives the third output signal and a clock signal so as to output a fourth output signal accordingly. The counting apparatus is for counting the number of the pulses of the fourth output signal so as to generate a digital code accordingly.

### FIELD OF THE INVENTION

The present invention relates to a temperature sensor, and more particularly to a temperature sensor implemented based on a signal delaying apparatus.

### BACKGROUND OF THE INVENTION

The current temperature sensors usually have complex design, large circuit size and high power consumption issues. For example, a temperature sensor, commonly seen in market and constituted by a proportional-to-absolute-temperature (PTAT) source, a bandgap voltage reference and an analog-to-digital converter, has a complex design, a large circuit size and consumes more power.

### SUMMARY OF THE INVENTION

Therefore, one object of the present invention is to provide a temperature sensor basically implemented based on a signal delaying apparatus so as to have a simpler design, smaller circuit size and less power consumption.

An embodiment of the present invention provides a temperature sensor, which includes a first signal delaying apparatus, a second signal delaying apparatus, a comparison apparatus, a multiplier and a counting apparatus. The first signal delaying apparatus is configured to receive a step signal, perform a phase delay operation on the received step signal according to a temperature degree, and thereby forming a first output signal. The second signal delaying apparatus is configured to receive the step signal, perform a phase delay operation on the received step signal, and thereby forming a second output signal; wherein the first signal delaying apparatus and the second signal delaying apparatus have the same internal circuit structure, and the second signal delaying apparatus operates at a zero temperature coefficient point. The comparison apparatus has a first input terminal, a second input terminal and a first output terminal. The first input terminal is configured to receive the first output signal; the second input terminal is configured to receive the second output signal; and the first output terminal is configured to output a third output signal. The multiplier has a third input terminal, a fourth input terminal and a second output terminal. The third input terminal is configured to receive the third output signal; the fourth input terminal is configured to receive a clock signal; and the second output terminal is configured to output a fourth output signal. The counting apparatus is configured to receive the fourth output signal, count the number of the pulses of the fourth output signal, and generate a digital code accordingly.

In summary, the temperature sensor according to the present invention is digitalized by employing two signal delaying apparatuses each having the same internal circuit structure, a comparison apparatus, a multiplier and a counting apparatus. Specifically, one signal delaying apparatus, can modulate the phase of its received signal according to a temperature degree; the other signal delaying apparatus can, due to operating at ZCT point, modulate the phase of its received signal independent from a temperature degree. In addition, each of the two signal delaying apparatuses is configured to receive a step signal and accordingly output an output signal; wherein the delay time of one output signal is related to the temperature degree and the manufacturing process of the associated signal delaying apparatus; the delay time of the other output signal is only related to the manufacturing process of the associated signal delaying apparatus but independent from the temperature degree.

The comparison apparatus is configured to receive the two output signals from the two signal delaying apparatuses, and correspondingly generate an output signal with a pulse. Because the two aforementioned signal delaying apparatuses are manufactured by the same manufacturing process, the pulse-enable time of the pulse of the output signal outputted from the comparison apparatus is related to the temperature degree only, and is independent from the manufacturing process of the signal delaying apparatuses. Moreover, the multiplier is configured to receive the output signal of the comparison apparatus and a clock signal, and correspondingly generate an output signal with a plurality of pulses; wherein these pulses are all located within the pulse-enable time of the pulse of the output signal outputted from the comparison apparatus. The counting apparatus is configured to count the number of pulses of the output signal outputted from the multiplier and generate a digital code correspondingly.

Because being completely designed by a digital means, the temperature sensor according to the present invention can have simpler design, smaller circuit size and less power consumption. Additionally, in the temperature sensor according to the present invention, because one signal delaying apparatus therein operates at ZCT point, the pulse-enable time of the pulse of the output signal outputted from the comparison apparatus is related to the temperature degree only, and is independent from the manufacturing process of the signal delaying apparatuses; and consequently, the digital code outputted from the counting apparatus can have a higher accuracy due to being independent from the variations of the manufacturing process of the signal delaying apparatus.

### BRIEF DESCRIPTION OF THE DRAWINGS

The present invention will become more readily apparent to those ordinarily skilled in the art after reviewing the following detailed description and accompanying drawings, in which:

FIG. 1 is a schematic circuit block diagram of a temperature sensor in accordance with an embodiment of the present invention;

FIG. 2 is a timing sequence diagram of signals associated with the temperature sensor depicted in FIG. 1;

FIG. 3 is a schematic internal circuit diagram of a signal delaying apparatus;

FIG. 4 is a schematic exemplified circuit view of the signal delaying unit;

FIG. 5 is a schematic circuit view of an inverter;

FIG. 6 is a schematic view illustrating the delay time and temperature relationship curve of the circuit depicted in FIG. 4 having a voltage source VDD of 1V; and

FIG. 7 is a schematic view illustrating relationship curves between the delay time and, the temperature degree of a signal delaying unit supplied with various source voltages.

### DETAILED DESCRIPTION OF PREFERRED EMBODIMENTS

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

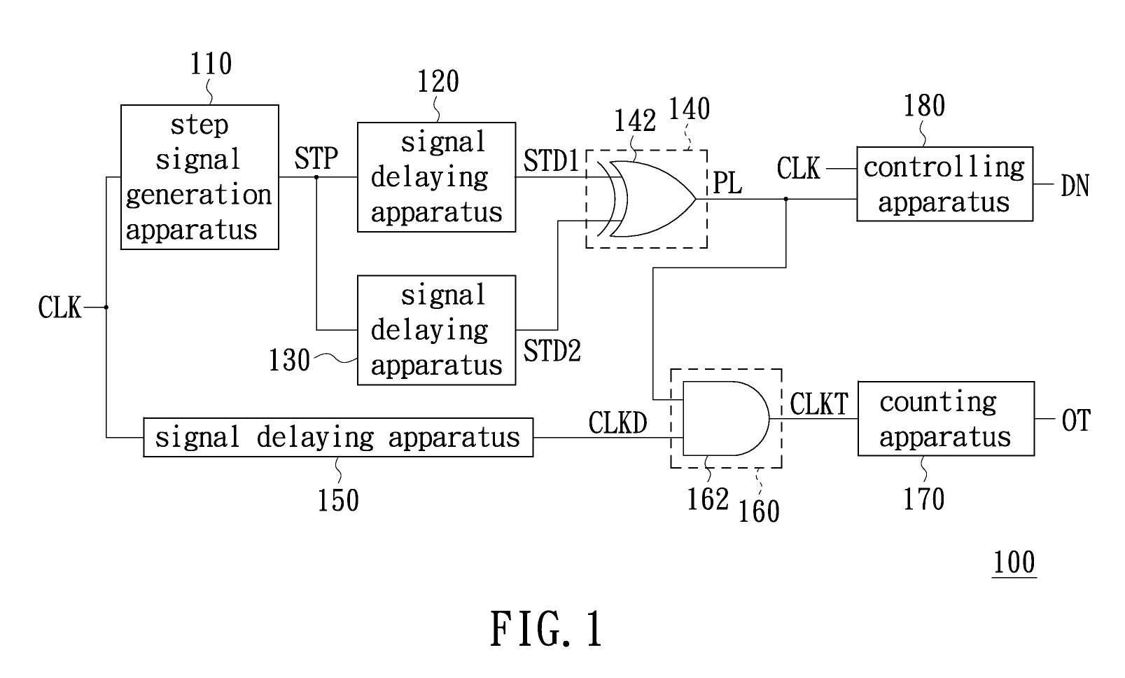

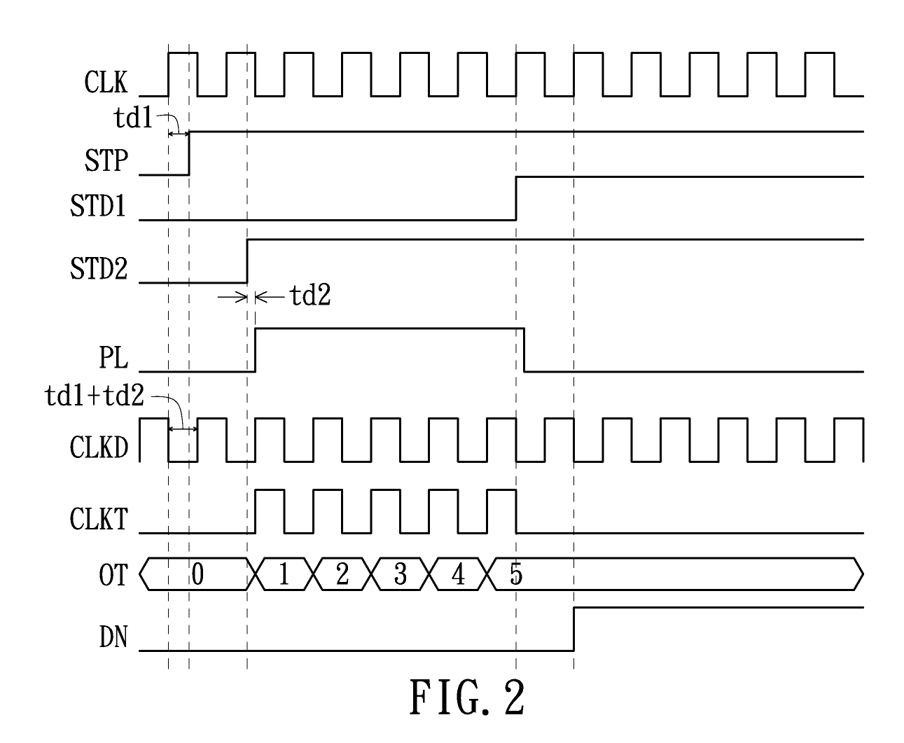

FIG. 1 is a schematic circuit block diagram of a temperature sensor in accordance with an embodiment of the present invention. FIG. 2 is a timing sequence diagram of signals associated with the temperature sensor depicted in FIG. 1. Please refer to FIGS. 1, 2 both. The temperature sensor 100 in this embodiment includes a step signal generation apparatus 110, signal delaying apparatuses 120, 130 and 150, a comparison apparatus 140, a multiplier 160, a counting apparatus 170 and a controlling apparatus 180.

The step signal generation apparatus 110 is configured to receive a clock signal CLK and accordingly generate a step signal STP; wherein the step signal STP has, due to the step signal generation apparatus 110, a phase delay td1 relative to the clock signal CLK. The signal delaying apparatus 120 is configured to receive the step signal STP, perform a phase delay operation on the received step signal STP according to a temperature degree so as to form an output signal STD1. In other words, the signal delaying apparatus 120 can modulate the received step signal STP to have a specific phase delay varying with a temperature degree. In addition, it is understood that the manufacturing process of the signal delaying apparatus 120 may also affect the delaying degree thereof; and thus, the delay time of the output signal STD1 is related to a temperature degree and the manufacturing process of the signal delaying apparatus 120 both.

The signal delaying apparatus 130, having an internal circuit structure same as that of the signal delaying apparatus 120, is configured to receive the step signal STP, perform a phase delay operation on the received step signal STP so as to form an output signal STD2. Because the signal delaying apparatus 130 operates at a zero temperature coefficient point (ZTC point), it is to be noted that the phase-delay degree of the output signal STD2 outputted from the signal delaying apparatus 130 is independent from the temperature degree; wherein the means for operating the signal delaying apparatus 130 in the ZTC point will be described in detail later. Similarly, the manufacturing process of the signal delaying apparatus 130 may also affect the delaying degree thereof; and thus, the delay time of the output signal STD2 is only related to the manufacturing process of the signal delaying apparatus 130, but is independent from the temperature degree.

The comparison apparatus 140 has two input terminals, to which the output signals STD1 from the signal delaying apparatus 120 and the output signals STD2 from the signal delaying apparatus 130 are supplied respectively, and one output terminal, from which an output signal PL is outputted; wherein the output signal PL has, due to the comparison apparatus 140, a phase delay td2 relative to the output signals STD2. In this embodiment, the comparison apparatus 140 outputs a logic-low output signal PL if the two received output signal STD and the step signal STP have the same logic level; alternatively, the comparison apparatus 140 outputs a logic-high output signal PL if the output signal STD and the step signal STP have different logic levels. As illustrated in FIG. 2, the output signal PL of the comparison apparatus 140 has a pulse. In this embodiment, because the signal delaying apparatuses 120, 130 are manufactured by the same manufacturing process, the pulse-enable time of the pulse of the comparison apparatus 140 is only related to the temperature degree, but is independent from the manufacturing process of the signal delaying apparatuses 120, 130.

According to the aforementioned configuration of the respective input signals and output signals, it is understood that the comparison apparatus 140 is configured to perform an exclusive-or (XOR) logic operation on the two received signals. In this embodiment, the comparison apparatus 140 can be implemented by an XOR logic operation apparatus; and the XOR logic operation apparatus can be implemented by an XOR gate 142, and no limitation. As such, the two input terminals of the XOR gate 142 are respectively referred to as the two input terminals of the comparison apparatus 140, and the output terminal of the XOR gate 142 is referred to as the output terminal of the comparison apparatus 140.

Additionally, in order to use the clock signal CLK to count the pulse-enable time of the output signal PL more accurately, another signal delaying apparatus 150 is disposed in the temperature sensor 100 and configured to perform a phase delay operation on the clock signal CLK supplied therein so as to output a clock signal CLKD for the counting of the pulse-enable time of the output signal PL. In other words, the rising edge of one pulse of the clock signal CLKD is configured to be located at that of the output signal PL, and the clock signal CLKD of the signal delaying apparatus 150 is configured to have a phase delay equal to that resulted from the step signal generation apparatus 110 (that is, td1) adding to that resulting from the comparison apparatus 140 (that is, td2). As such, through configuring the clock signal CLKD to have a delay time (that is, td1+td2) equal to that of the output signal PL, the rising edge of the pulse of the output signal PL can be exactly indicated by a rising edge of one pulse in the clock signal CLKD. Therefore, the pulse-enable time of the pulse of the output signal PL can be counted more accurately by the clock signal CLKD.

The multiplier 160 has two input terminals, to which the output signal PL from the comparison apparatus 140 and the clock signal CLKD from the signal delaying apparatus 150 are supplied respectively, and one output terminal, from which an output signal CLKT is outputted. In this embodiment, the multiplier 160 outputs a logic-low output signal CLKT if at least one of the output signal PL and the clock signal CLKD supplied therein having a logic-low level; alternatively, the multiplier 160 outputs a logic-high output signal CLKT if the output signal PL and the clock signal CLKD supplied therein both having a logic-high level. In addition, as illustrated in FIG. 2, the output signal CLKT includes a plurality of pulses, which all are located within the pulse-enable time of the pulse of the output signal PL.

According to the aforementioned configuration of the respective input signals and output signals, it is understood that the multiplier 160 is configured to perform an AND logic operation on the two received signals. Thus, the multiplier 160 can be implemented by an AND logic operation apparatus; and the AND logic operation apparatus can be implemented by an AND gate 162, and no limitation. As such, the two input terminals of the AND gate 162 are respectively referred to as the two input terminals of the multiplier 160, and the output terminal of the AND gate 162 is referred to as the output terminal of the multiplier 160.

The counting apparatus 170 is configured to receive the clock signal CLKT from the multiplier 160, count the number of pulses in the clock signal CLKT and accordingly output a digital code OT. In the temperature sensor 100 according to the present invention, because one signal delaying apparatus therein operates at ZCT point, the pulse-enable time of the pulse of the output signal PL outputted from the comparison apparatus 140 is related to the temperature degree only, and is independent from the manufacturing process of the signal delaying apparatuses; and consequently, the digital code OT outputted from the counting apparatus 170 can have a higher accuracy due to being independent from the variations of the manufacturing process of the signal delaying apparatus. And thus, the back-end circuit (not shown) associated with the temperature sensor 100 can correctly determine the current temperature degree based on the digital code OT outputted from the counting apparatus 170.

Additionally, in order to determine the length of the digital code OT so that the back-end circuit can accordingly determine the current temperature degree, the controlling apparatus 180 in the temperature sensor 100 is configured to output a completion signal DN for indicating the end of the digital code OT; wherein the controlling apparatus 180 generates the completion signal DN according to the received clock signal CLK and the output signal PL from the comparison apparatus 140. Specifically, as illustrated in FIG. 2, the controlling apparatus 180 is configured to detect an occurrence of a falling edge of the pulse of the output signal PL by a rising edge of a pulse of the clock signal CLK. Specifically, the controlling apparatus 180 converts, upon once the aforementioned falling edge of a pulse of the output signal PL is detected, the completion signal DN from logic-low to logic-high so as to indicate the end of the digital code OT. In response to another design requirement, it is understood that the controlling apparatus 180 may be configured to convert the completion signal DN from logic-high to logic-low if the aforementioned falling edge is detected.

Through being completely implemented in a digital manner or design, the temperature sensor 100 according to the present invention can have a simpler circuit design, smaller circuit size and less power consumption. In addition, according to the aforementioned descriptions, the temperature sensor 100 can have a more-precise operation by employing the signal delaying apparatus 150 and the associated back-end circuit can have a more-precise operation by employing the controlling apparatus 180. However, it is understood that the temperature sensor 100 can be implemented without the signal delaying apparatus 150 and the controlling apparatus 180 in another embodiment according to the present invention, in response to another design requirement. As such, the multiplier 160 is, instead of being supplied with the clock signal CLKD, configured to be supplied with the clock signal CLK through one input terminal thereof if the signal delaying apparatus 150 is not being employed in the temperature sensor 100. In addition, it is understood that the step signal STP in the temperature sensor 100 can be obtained from external source, instead of being generated by the step signal generation apparatus 110; correspondingly, the signal delaying apparatus 150 is configured to have a phase delay equal to that of the comparison apparatus 140 only, so that the rising edge of one pulse of the clock signal CLKD can be located at that of the output signal PL.

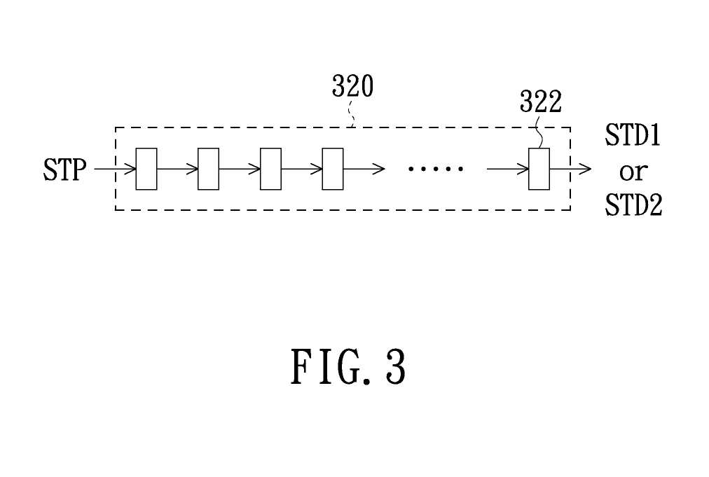

The implementation means of the signal delaying apparatuses 120, 130 can be exemplified by FIG. 3, which is a schematic internal circuit diagram of a signal delaying apparatus 320. As shown, the signal delaying apparatus 320 includes a plurality of cascaded signal delaying units 322; specifically, the first-stage signal delaying unit 322 is configured to receive the step signal STP, and the last-stage one is configured to output the output signal STD1 or STD2. In addition, it is understood that each of the signal delaying units 322 is configured to perform a phase delay operation on the signal supplied therein.

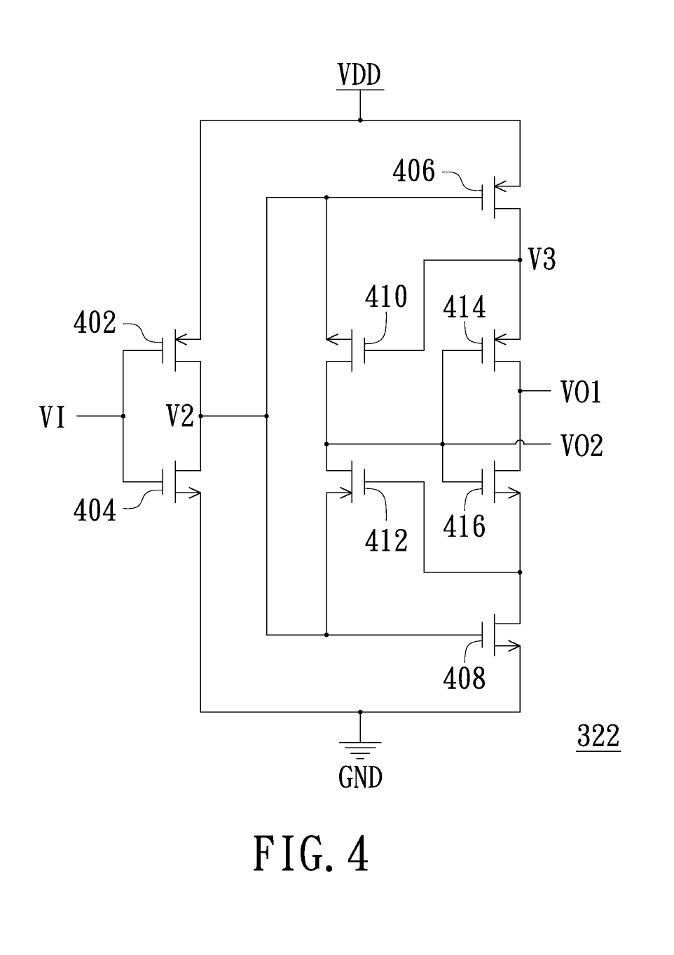

FIG. 4 is a schematic exemplified circuit view of the signal delaying unit 322. As shown, the signal delaying unit 322 includes four p-type transistors 402, 406, 412 and 414 and four n-type transistors 404, 408, 410 and 416; wherein the aforementioned transistors each can be implemented by a metal oxide semiconductor field effect transistor (MOSFET). Specifically, the p-type transistor 402 is configured to have its one source/drain electrically connected to a source voltage VDD; and its gate referred to as an input terminal of the signal delaying unit 322 and to which an input signal VI is inputted. The n-type transistor 404 is configured to have its one source/drain electrically connected to another source/drain of the p-type transistor 402; its another source/drain electrically connected to a reference voltage (for example, electrically connected to ground GND); and its gate electrically connected to the input terminal of the signal delaying unit 322. The p-type transistor 406 is configured to have its one source/drain electrically connected to the source voltage VDD; and its gate electrically connected to another source/drain of the p-type transistor 402. The n-type transistor 408 is configured to have its one source/drain electrically connected to the reference voltage (GND); and its gate electrically connected to another source/drain of the p-type transistor 402.

Moreover, the n-type transistor 410 is configured to have its one source/drain electrically connected to the gate of the p-type transistor 406; and its gate electrically connected to another source/drain of the p-type transistor 406. The p-type transistor 412 is configured to have its one source/drain electrically connected to another source/drain of the n-type transistor 410; its another source/drain electrically connected to the gate of the n-type transistor 408; and its gate electrically connected to another source/drain of the n-type transistor 408. The p-type transistor 414 is configured to have its one source/drain electrically connected to another source/drain of the p-type transistor 406; its another source/drain referred to as one output terminal of the signal delaying unit 322 and from which an output signal VO1 is outputted; and its gate electrically connected to another source/drain of the n-type transistor 410. The n-type transistor 416 is configured to have its one source/drain electrically connected to another source/drain of the p-type transistor 414; its another source/drain electrically connected to the gate of the p-type transistor 412; and its gate electrically connected to the gate of the p-type transistor 414 and another source/drain of the n-type transistor 410, and referred to as another output terminal of the signal delaying unit 322 and from which an output signal VO2 is outputted.

In the signal delaying unit 322 as depicted in FIG. 4, the output signal VO1 and the input signal VI are configured to have the same phase; and the output signal VO2 and the input signal VI are configured to have a phase opposite to each other. Thus, the signal delaying unit 322 can function as a buffer if the output signal VO1 thereof is referred to as an input signal of a next-stage signal delaying unit; alternatively, the signal delaying unit 322 can function as an inverter if the output signal VO2 thereof is referred to as an input signal of a next-stage signal delaying unit. Moreover, it is to be noted that the number of the signal delaying units 322 in the signal delaying apparatus 320 must be even if the signal delaying units 322 each is functioning as an inverter.

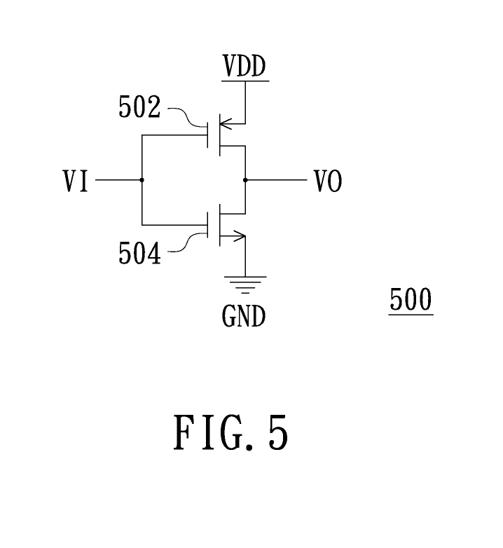

Following is the description for explaining how an inverter can delay the phase of the received signal according to a temperature degree; and accordingly how the signal delaying apparatus 320 delaying the phase of the received signal according to a temperature degree is explained. FIG. 5 is a schematic circuit view of an inverter 500. As shown, the inverter 500 includes a p-type transistor 502 and an n-type transistor 504; wherein in the embodiment, the p-type transistor 502 and the n-type transistor 504 each can be implemented by a metal oxide semiconductor field effect transistor. Specifically, the p-type transistor 502 is configured to have its one source/drain electrically connected to a source voltage VDD; its another source/drain referred to as an output terminal of the inverter 500 and from which an output signal VO is outputted; and its gate referred to as an input terminal of the inverter 500 and to which an input signal VI is inputted. The n-type transistor 504 is configured to have its one source/drain electrically connected to the output terminal of the inverter 500; its another source/drain electrically connected to a reference voltage (for example, electrically connected to ground GND); and its gate electrically connected to the input terminal of the inverter 500.

The delay time of the inverter 500 in FIG. 5 can be expressed by the following two equations (1), (2):

$$\begin{matrix}{t}_{PHL} = \frac{2 {C}_{L} {V}_{TN}}{{{K}_{N} ( VDD - {V}_{TN} )}^{2}} + \frac{{C}_{L}}{{K}_{N} ( VDD - {V}_{TN} )} \times ln ( \frac{1.5 VDD - 2 {V}_{TN}}{0.5 VDD} ) & ( 1 ) \\ {t}_{PLH} = \frac{2 {C}_{L} {V}_{TP}}{{{K}_{P} ( VDD + {V}_{TP} )}^{2}} + \frac{{C}_{L}}{{K}_{P} ( VDD + {V}_{TP} )} \times ln ( \frac{1.5 VDD + 2 {V}_{TP}}{0.5 VDD} ) & ( 2 )\end{matrix}$$

wherein t_{PHL} stands for a delay time of the inverter 500 while the input signal VI is being converted from logic-high into logic-low; t_{PLH} stands for a delay time of the inverter 500 while the input signal VI is being converted from logic-low into logic-high; C_{L} stands for a transconductance parameter and an effective load capacitance of the inverter 500, in other words, C_{L} represents a loading; V_{TN} stands for a threshold voltage of the n-type transistor 504; V_{TP} stands for a threshold voltage of the p-type transistor 502; VDD is a source voltage; K_{N}=μₙC_{OX}(W/L)_{N}; KP=μₚC_{OX}(W/L)ₚ. In addition, μ_{N} stands for a carrier mobility of the n-type transistor 504; μₚ stands for a carrier mobility of the p-type transistor 502; C_{OX} stands for a gate oxide capacitance per unit area; (W/L)_{N} stands for a ratio of the gate width to the gate length of the n-type transistor 504; (W/L)ₚ stands for a ratio of the gate width to the gate length of the p-type transistor 502.

According to the equations (1) and (2), the average delay time tₚ of the inverter 500 can be obtained by the following equation (3):

$${t}_{P} = \frac{{t}_{PLH} + {t}_{PHL}}{2} = \frac{( L / W ) {C}_{L}}{μ {C}_{OX} ( VDD - {V}_{T} )} \times ln ( \frac{1.5 VDD + 2 {V}_{T}}{0.5 VDD} ) \qquad ( 3 )$$

In equation (3), because the carrier mobility μ and the threshold voltage V_{T} both are inversely proportional to temperature degree, the carrier mobility μ and the threshold voltage V_{T} each decreases and thereby increasing the average delay time tₚ of the inverter 500 with increasing temperature degree; alternatively, the carrier mobility μ and the threshold voltage V_{T} each increases and thereby decreasing the average delay time tₚ of the inverter 500 with decreasing temperature degree. Therefore, the inverter 500 can modulate the phase-delay degree of the input signal VI supplied therein according to a temperature degree.

Based on the above description, four average delay times tₚ associated with the signal delaying units 322 in FIG. 4 can be obtained by the following equations (4)˜(7):

$$\begin{matrix}{t}_{P ( V 2 - V 1 )} = \frac{{t}_{PLH} + {t}_{PHL}}{2} = \frac{( L / W ) {C}_{L 1}}{μ {C}_{OX} ( VDD - {V}_{T} )} \times ln ( \frac{1.5 VDD - 2 {V}_{T}}{0.5 VDD} ) & ( 4 ) \\ {t}_{P ( V 3 - V 2 )} = \frac{{t}_{PLH} + {t}_{PHL}}{2} = \frac{( L / W ) {C}_{L 2}}{μ {C}_{OX} ( VDD - {V}_{T} )} \times ln ( \frac{1.5 VDD - 2 {V}_{T}}{0.5 VDD} ) & ( 5 ) \\ {t}_{P ( V O 2 - V 3 )} = \frac{{t}_{PLH} + {t}_{PHL}}{2} = \frac{( L / W ) {C}_{L 3}}{μ {C}_{OX} ( VDD - {V}_{T} )} \times ln ( \frac{1.5 VDD - 2 {V}_{T}}{0.5 VDD} ) & ( 6 ) \\ {t}_{P ( V O 1 - V O 2 )} = \frac{{t}_{PLH} + {t}_{PHL}}{2} = \frac{( L / W ) {C}_{L 4}}{μ {C}_{OX} ( VDD - {V}_{T} )} \times ln ( \frac{1.5 VDD - 2 {V}_{T}}{0.5 VDD} ) & ( 7 )\end{matrix}$$

wherein V2, VI, V3, VO2 and VO1 each presents a signal in the signal delaying units 322 depicted in FIG. 4; VI is an input signal; VO1 and VO2 each is an output signal; C_{L1}˜C_{L4} each stands for a loading.

Equation (8) can be derived from the aforementioned equations (4)˜(7):

$${t}_{P ( V O 1 - V 1 )} = \frac{( L / W )}{μ {C}_{OX} ( VDD - {V}_{T} )} \times ln ( \frac{1.5 VDD + 2 {V}_{T}}{0.5 VDD} ) \times ( {C}_{L 1} + {C}_{L 2} + {C}_{L 3} + {C}_{L 4} ) \qquad ( 8 )$$

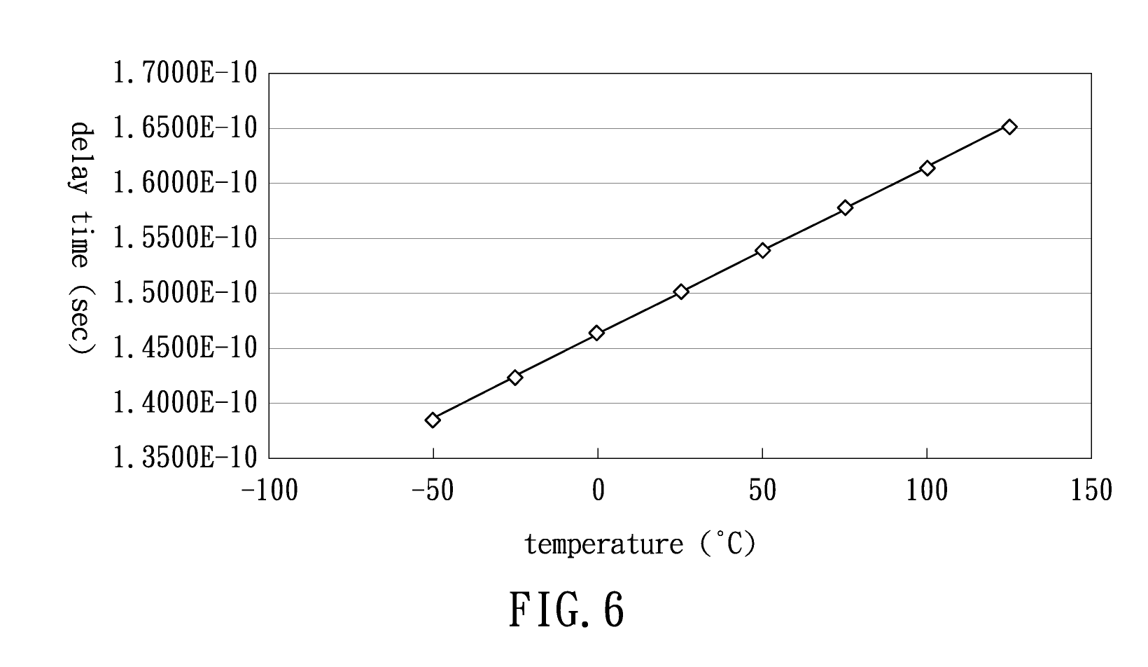

In equation (8), because the carrier mobility μ and the threshold voltage V_{T} both are inversely proportional to temperature degree, the carrier mobility μ and the threshold voltage V_{T} each decreases and thereby increasing the average delay time t_{p(VO1-VI)} of the signal delaying units 322 in FIG. 4 with increasing temperature degree; alternatively, the carrier mobility μ and the threshold voltage V_{T} each increases and thereby decreasing the average delay time t_{p(VO1-VI)} with decreasing temperature degree. Therefore, the signal delaying unit 322 in FIG. 4 can modulate the phase-delay degree of the input signal VI supplied therein according to a temperature degree. Specifically, the delay time and temperature relationship curve of the circuit in FIG. 4 is illustrated in FIG. 6; wherein the voltage source VDD of the circuit depicted in FIG. 4 is 1V, and the delay time is measured in seconds and the temperature is measured in ° C.

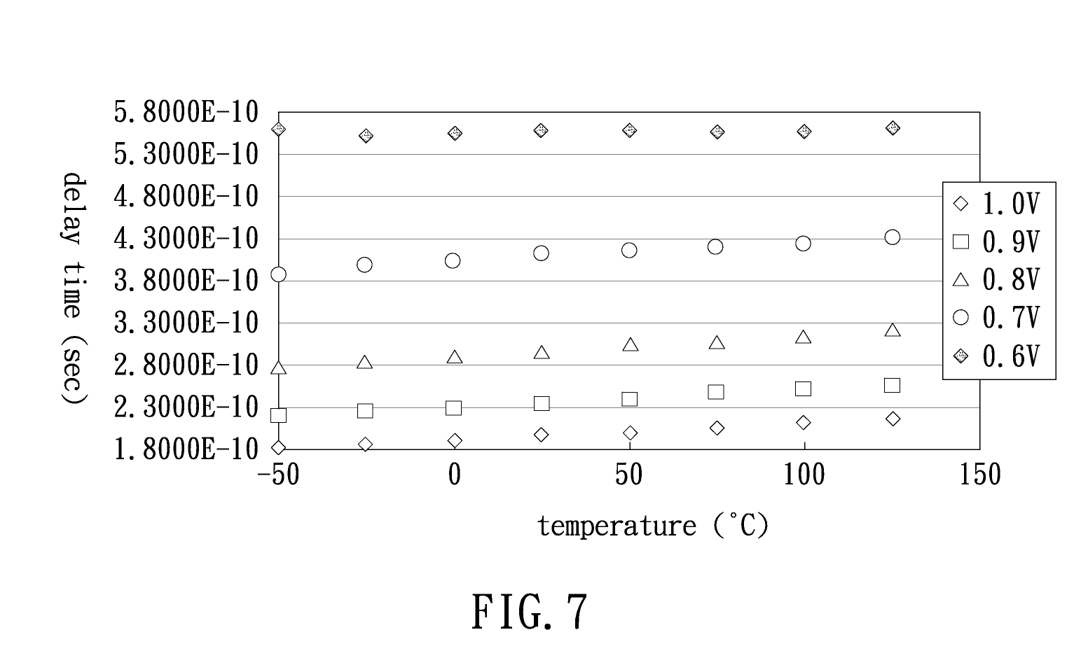

In this embodiment, it is to be noted that the source voltage VDD, supplied into each signal delaying unit 322 in the signal delaying apparatus 320, must be configured to have a voltage value much greater than the threshold voltage V_{T} of each transistor in the signal delaying apparatus 320 if the signal delaying apparatus 120 in FIG. 1 has a circuit structure same as that of the signal delaying apparatus 320. And, the source voltage VDD must be modulated to a specific value if the signal delaying apparatus 130 in FIG. 1 has a circuit structure same as that of the signal delaying apparatus 320. FIG. 7 is a schematic view illustrating relationship curves between the delay time and the temperature degree obtained by supplying various source voltages VDD to the signal delaying units 322. As shown, there are five relationship curves respectively derived from five source voltages VDD of 1.0V, 0.9V, 0.8V, 0.7V and 0.6V. Specifically, the relationship curve is approaching horizontal line (that is, having a slope approximate to zero) with decreasing the source voltage VDD from 1.0V to 0.6V. In other words, the delay time of the signal delaying unit 322 basically is, while the source voltage VDD is being modulated to 0.6V, independent from the temperature degree. In addition, it is to be noted that the relationship curve has a slope greater than zero if the source voltage VDD is greater than 0.6V; and the relationship curve has a slope smaller than zero if the source voltage VDD is smaller than 0.6V.

In summary, the temperature sensor according to the present invention is digitalized by employing two signal delaying apparatuses each having the same internal circuit structure, a comparison apparatus, a multiplier and a counting apparatus. Specifically, one signal delaying apparatus can modulate the phase of its received signal according to a temperature degree; the other one signal delaying apparatus can, due to being operated at ZCT point, modulate the phase of its received signal independent from a temperature degree. In addition, the two signal delaying apparatuses each is configured to receive a step signal and accordingly output an output signal; wherein the delay time of one output signal is related to the temperature degree and the manufacturing process of the associated signal delaying apparatus; the delay time of the other output signal is only related to the manufacturing process of the associated signal delaying apparatus, but is independent from the temperature degree.

The comparison apparatus is configured to receive the two output signals from the two signal delaying apparatuses, and correspondingly generate an output signal with a pulse. Because the two aforementioned signal delaying apparatuses are manufactured by the same manufacturing process, the pulse-enable time of the pulse of the output signal outputted from the comparison apparatus is related to the temperature degree only, and is independent from the manufacturing process of the signal delaying apparatuses. Moreover, the multiplier is configured to receive the output signal of the comparison apparatus and a clock signal, and correspondingly generate an output signal with a plurality of pulses; wherein these pulses are all located within the pulse-enable time of the pulse of the output signal outputted from the comparison apparatus. The counting apparatus is configured to count the number of pulses of the output signal outputted from the multiplier and generate a digital code correspondingly.

Because being completely designed by a digital means, the temperature sensor according to the present invention can have simpler design, smaller circuit size and less power consumption. Additionally, in the temperature sensor according to the present invention, because one signal delaying apparatus therein operates at ZCT point, the pulse-enable time of the pulse of the output signal outputted from the comparison apparatus is related to the temperature degree only, but is independent from the manufacturing process of the signal delaying apparatuses; and consequently, the digital code outputted from the counting apparatus can have a higher accuracy due to being independent from the variations of the manufacturing process of the signal delaying apparatus.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A temperature sensor, comprising:
a first signal delaying apparatus configured to receive a step signal, perform a phase delay operation on the received step signal according to a temperature degree, and thereby forming a first output signal;
a second signal delaying apparatus configured to receive the step signal, perform a phase delay operation on the received step signal, and thereby forming a second output signal; wherein the first signal delaying apparatus and the second signal delaying apparatus have the same internal circuit structure, and the second signal delaying apparatus operates at a zero temperature coefficient point;
a comparison apparatus having a first input terminal, a second input terminal and a first output terminal, wherein the first input terminal is configured to receive the first output signal, the second input terminal is configured to receive the second output signal, the first output terminal is configured to output a third output signal;
a multiplier having a third input terminal, a fourth input terminal and a second output terminal, wherein the third input terminal is configured to receive the third output signal, the fourth input terminal is configured to receive a first clock signal, the second output terminal is configured to output a fourth output signal; and
a counting apparatus configured to receive the fourth output signal, count the number of the pulses of the fourth output signal, and generate a digital code correspondingly.

2. The temperature sensor according to claim 1, wherein each of the first signal delaying apparatus and the second signal delaying apparatus comprises a plurality of cascaded signal delaying units, the first-stage signal delaying unit in the first signal delaying apparatus is configured to receive the step signal, the last-stage signal delaying unit in the first signal delaying apparatus is configured to output the first output signal; wherein the first-stage signal delaying unit in the second signal delaying apparatus is configured to receive the step signal, the last-stage signal delaying unit in the second signal delaying apparatus is configured to output the second output signal.

3. The temperature sensor according to claim 2, wherein each signal delaying unit comprises:
a first p-type transistor configured to have its one source/drain electrically connected to a source voltage, and its gate referred to as an input terminal of the signal delaying unit;
a first n-type transistor configured to have its one source/drain electrically connected to another source/drain of the first p-type transistor, its another source/drain electrically connected to a reference voltage, and its gate electrically connected to the input terminal of the signal delaying unit;
a second p-type transistor configured to have its one source/drain electrically connected to the source voltage, and its gate electrically connected to another source/drain of the first p-type transistor;
a second n-type transistor configured to have its one source/drain electrically connected to the reference voltage, and its gate electrically connected to another source/drain of the first p-type transistor;
a third n-type transistor configured to have its one source/drain electrically connected to the gate of the second p-type transistor, and its gate electrically connected to another source/drain of the second p-type transistor;
a third p-type transistor configured to have its one source/drain electrically connected to another source/drain of the third n-type transistor, its another source/drain electrically connected to the gate of the second n-type transistor, and its gate electrically connected to another source/drain of the second n-type transistor;
a fourth p-type transistor configured to have its one source/drain electrically connected to another source/drain of the second p-type transistor, its another source/drain referred to as an output terminal of the signal delaying unit, and its gate electrically connected to another source/drain of the third n-type transistor; and
a fourth n-type transistor configured to have its one source/drain electrically connected to the output terminal of the signal delaying unit, its another source/drain electrically connected to the gate of the third p-type transistor, and its gate electrically connected to another source/drain of the third n-type transistor.

4. The temperature sensor according to claim 2, wherein each signal delaying unit comprises:
a first p-type transistor configured to have its one source/drain electrically connected to a source voltage, and its gate referred to as an input terminal of the signal delaying unit;
a first n-type transistor configured to have its one source/drain electrically connected to another source/drain of the first p-type transistor, its another source/drain electrically connected to a reference voltage, and its gate electrically connected to the input terminal of the signal delaying unit;
a second p-type transistor configured to have its one source/drain electrically connected to the source voltage, and its gate electrically connected to another source/drain of the first p-type transistor;
a second n-type transistor configured to have its one source/drain electrically connected to the reference voltage, and its gate electrically connected to another source/drain of the first p-type transistor;
a third n-type transistor configured to have its one source/drain electrically connected to the gate of the second p-type transistor, and its gate electrically connected to another source/drain of the second p-type transistor;
a third p-type transistor configured to have its one source/drain electrically connected to another source/drain of the third n-type transistor, its another source/drain electrically connected to the gate of the second n-type transistor, and its gate electrically connected to another source/drain of the second n-type transistor;
a fourth p-type transistor configured to have its one source/drain electrically connected to another source/drain of the second p-type transistor, and its gate electrically connected to another source/drain of the third n-type transistor and referred to as an output terminal of the signal delaying unit; and
a fourth n-type transistor configured to have its one source/drain electrically connected to another source/drain of the fourth p-type transistor, its another source/drain electrically connected to the gate of the third p-type transistor, and its gate electrically connected to the output terminal of the signal delaying unit.

5. The temperature sensor according to claim 1, further comprising a third signal delaying apparatus configured to receive a second clock signal, perform a phase delay operation on the received second clock signal, and thereby forming the first clock signal, wherein the rising edge of one pulse of the first clock signal is located at the rising edge of one pulse of the third output signal.

6. The temperature sensor according to claim 1, further comprising a step signal generation apparatus configured to provide the step signal.

7. The temperature sensor according to claim 6, further comprising a third signal delaying apparatus configured to receive a second clock signal, perform a phase delay operation on the received second clock signal, and thereby forming the first clock signal, wherein the rising edge of one pulse of the first clock signal is located at the rising edge of one pulse of the third output signal.

8. The temperature sensor according to claim 1, wherein the third output signal has a logic-low level if the first input terminal and the second input terminal of the comparison apparatus have the same logic level, the third output signal has a logic-high level if the first input terminal and the second input terminal of the comparison apparatus have different logic levels.

9. The temperature sensor according to claim 8, wherein the comparison apparatus comprises an XOR logic operation apparatus.

10. The temperature sensor according to claim 9, wherein the XOR logic operation apparatus comprises an XOR gate, the two input terminals of the XOR gate are respectively referred to as the first input terminal and the second input terminal, and the output terminal of the XOR gate is referred to as the first output terminal.

11. The temperature sensor according to claim 1, wherein the fourth output signal has a logic-low level if at least one of the third input terminal and the fourth input terminal has a logic-low level, the fourth output signal has a logic-high level if the third input terminal and the fourth input terminal both have a logic-high level.

12. The temperature sensor according to claim 11, wherein the multiplier comprises an AND logic operation apparatus.

13. The temperature sensor according to claim 12, wherein the AND logic operation apparatus comprises an AND gate, the two input terminals of the AND gate are respectively referred to as the third input terminal and the fourth input terminal, and the output terminal of the AND gate is referred to as the second output terminal.
